(19) United States
(12) Patent Application Publication
(10) Pub. No.: US 2018/0250620 A1
(43) Pub. Date: Sep. 6, 2018

(54) AXIAL FLOW DEMISTER

(71) Applicant: NOV Process & Flow Technologies AS, Fornebu (NO)

(72) Inventors: Geir VINGELVEN, Hovik (NO); Marcel MICHAELIS, Oslo (JP); René MIKKELSEN, Richmond (GB)

(21) Appl. No.: 15/755,372

(22) PCT Filed: Aug. 26, 2016
(86) PCT No.: PCT/EP2016/070208

§ 371 Date: Feb. 26, 2018

(30) Foreign Application Priority Data
Aug. 28, 2015 (NO) 20151102

(51) Int. Cl. B01D 45/16; B01D 53/24; B04C 3/06; B01D 45/08

(52) U.S. Cl. CPC B01D 45/16; B01D 53/24; B04C 2003/006; B01D 45/08; B04C 3/06

(57) ABSTRACT

A device for removal of a liquid from a gas-liquid mixture, comprising an inner tube with an upstream gas-liquid mixture inlet and a downstream gas outlet, a swirl body arranged within said inner tube, at least one opening in the wall or at the end of the inner tube downstream the swirl body for a recycle flow, and a conduit from the at least one opening in the wall of the inner tube to at least one recycle return opening in the swirl body. The swirl body comprises a hub part and one or more swirling elements connected thereto, the hub part comprises a cylindrical shaped main hub and a downstream end hub, and the at least one recycle return opening is arranged in the end hub. The one or more swirling elements are continuous and directly connected to the main hub and the end hub.

The present invention relates to a device for removal of a liquid from a gas-liquid mixture. Especially the invention relates to an improved axial flow demister for demisting a gas flow. Further, the present invention relates to optimize capacity, performance and avoiding liquid film and droplets being forced into the core of an axial flow demister and limit entrainment.

### BACKGROUND

In many processes it is beneficial to be able to remove liquid droplets from a gas flow; such a process is often referred to as demisting. For instance, prior to increasing the pressure of produced natural gas in a compressor sensitive to the presents of liquid it is of advantage to be able to remove all liquid from the gas stream up stream the compressor.

The general working principle and design of an axial flow demister is well known in the art. EP 1147799 A1 describes a device referred to as a axial flow cyclone, for the removal of a liquid from a gas/liquid mixture, comprising a tube, a swirl body placed in this tube and having one or more swirling members, at least one outflow opening in the wall of the tube downstream of the swirl body, a channel connected with a downstream end to the upstream end of an internal channel in the swirl body, an upstream end of the channel being in fluid communication with the at least one outflow opening in the tube, the internal channel in the swirl body having at least one outlet opening. The gas flow to be treated is past through the tube and as it is brought in contact with the swirling members the gas flow will start to swirl and the cyclone like movement results in the liquid with higher density to be concentrated on the tube wall. The liquid on the tube wall together with a part of the gas will leave the tube through the outflow opening. The channel provides for recycle of the gas that together with liquid is past through the outflow opening. The liquid is removed before the flow enters the internal channel of the swirl body.

Re-entrainment is also recognized to be a major issue related to the performance of an axial flow demister, Austrheim, T., Gjertsen, L. H. and Hoffmann A. C. “Re-entrainment correlations for demisting cyclones acting at elevated pressures on a range of fluids” Energy & Fuels 21 (2007) pages 2969-2976.

### PRIOR ART

The main elements of the axial flow cyclone are a cyclone tube and a swirl body inside the tube. The gas flows through these cyclones and the swirling members or vanes of the swirl body in the cyclone tube bring the gas flow into a swirling motion that causes the liquid droplets present in the gas to migrate to the tube wall due to the centrifugal forces generated by this swirling motion. Eventually, the droplets will be caught by the tube wall and will form a liquid film, which will spiral upwards on the inner tube wall. In order to transport this separated-off liquid to a liquid collection chamber of a cyclone/demister and eventually via a liquid drain to the liquid compartment of the gas/liquid separation vessel, outflow openings in the form of slots are present in the tube wall. In the prior art solution according to EP 1147799 A1 these slots are in most cases longitudinal, i.e. parallel to the axis of the cyclone tube the recycle flow will be directed radially outwards towards the cyclone tube and will “crash” with the swirling main flow. The upstream end of the slots is arranged immediately above the downstream end of the swirl body.

Other publications disclosing axial flow demisters include EP1154862, US2009/0242481, U.S. Pat. No. 4,238,210 and US20120103423.

In the prior art solution according to EP 1147799 A1 the outlet openings in the swirl body are arranged on a cylindrical central section of the swirl body upstream the downstream end of the swirl body. The swirling members are also only connected to the central cylindrical section of the swirl body. In one embodiment the outlet openings in the swirl body are situated downstream of the downstream ends of the swirling members. In another embodiment the outlet opening in the swirl body is situated between the swirling members near a downstream end of the swirling members.

According to EP 1147799 A1 the effect of the outlet opening of the swirl body being situated at a position upstream from a downstream end of the swirl body, is a full benefit of the swirl created by the swirl body resulting in an efficient demisting of the gas flowing out of the outlet. The recycle gas is introduced at a position in the main gas flow where the swirling motion is very intense. As a consequence, the recycle gas and the main gas flows will mix very quickly and the liquid which is present in the recycle gas flow will be separated from the gas flow. It is further stated that the provided solution makes anti-creep rings obsolete. Anti-creep rings are known from NL-1003408 where they are installed on the swirl body downstream the outlets to prevent re-entrainment of liquid present at the swirl body.

### Objectives of the Invention

The aim of the present invention is to provide a device, which removes liquid droplets from a gas stream where the liquid content in the gas is low by improving the recycle flow reentering the main flow in the cyclone body. Especially providing a method and system which reduces any negative impact on the main gas flow and which provides improved liquid creep prevention to the core of the cyclone.

A further aim is to limit and preferably eliminate entrainment of liquid droplets.

It is also an aim to limit the pressure loss without negatively affecting the separation efficiency.

Recycle is essential to achieve good performance, one objective is to achieve recycling without negatively effecting the induced feed swirl fluid. Another objective is to achieve higher recycle rates without accordantly reducing feed capacity.

The present inventors have come up with solutions to reach one or more of these goals.

The present invention provides a device for removal of a liquid from a gas-liquid mixture, particularly an axial flow demister, comprising an inner tube with an upstream gas-liquid mixture inlet and a downstream gas outlet, a swirl body arranged within said inner tube, at least one opening in the wall or at the end of the inner tube downstream the swirl body for a recycle flow, a conduit from the at least one opening in the wall of the inner tube to at least one recycle return opening in the swirl body, wherein the swirl body comprises a hub part and one or more swirling elements connected thereto, wherein the hub part comprises a cylindrical or barrel shaped main hub with an outer diameter and a downstream end hub, wherein the at least one recycle return opening is arranged in the end hub, wherein the one or more swirling elements are continuous and directly connected to the main hub and the end hub, characterized in that the swirl body comprises a recycle return section comprising said at least one return opening in the end hub and that within the recycle return section the one or more swirling element(s) extend further radially inwards than the outer diameter of the main hub.

In the present invention the one or more swirling elements are continuous and directly connected both to the main hub and the end hub.

The driving force of the recycle flow is caused by the pressure difference of the pressure at the opening(s) in the wall of the inner tube and the pressure at the recycle return opening(s) in the swirl body. The greater radial distance between the opening(s) in the wall of the inner tube and the recycle return opening(s) in the swirl body, the larger the pressure difference will be, and consequentially the higher the driving force for the recycle flow will be.

If the recycle opening had been axially unrestricted, the liquid in the recycle flow would be trapped in the downstream vortex flow, i.e. droplets would be forced into the core of an axial flow demister and exits out unseparated.

The present invention enables a high driving recycle flow force, by enabling large radial distance between the opening(s) in the wall of the inner tube and the recycle return opening(s) in the swirl body, and at the same time enabling the same deflection area as the flow from the main hub by having a common end hub. Importantly, this is achieved with limited disturbance of the main flow generating swirl causing the pressure difference, driving the recycle flow in the first place, as the recycle flow has the swirling element extending from a radially position further inward that the outer diameter of the main hub, the swirling element being continuously (integral) with the swirling element of the upstream main hub flow.

Further, a recycle return stream re-entering through the return opening will come in contact with the swirling element at a position further radially inwards than the diameter of the main hub. Here the pressure will be lower than if returned at the outer diameter of the main hub instead. In this way an improved driving force is obtained with less disturbance of the main flow from the main hub. The main hub will act as a shielding for the recycle inlet. Here the radially inward extending swirling elements in the recycle return section provide the recycle stream to gradually change into a helical flow pattern aligned or adjoined with the a helically flow pattern of the stream from the main hub. This aligned or adjoined helical flow pattern of the return stream further reduces the disturbing of the stream from the main hub.

Additionally, liquids in the recycle return stream can be transferred to any liquid droplets already deposited at the surface of the swirling elements from the main hub, and visa versa, liquids in the gas from the main hub can be transferred to any liquid droplets deposited at the surface of the swirling elements extending radially inwards in the end hub, which further improves the liquid-gas separation. At the same time the accumulated droplets from main and recycle stream deposited on the swirling element will exit the end hub jointly and thereby more quickly provide a liquid film on the inner tube downstream the swirl body, also improving the overall gas-liquid efficiency of the demisting cyclone.

The outer diameter of the main hub is to be understood as the largest radial outer diameter of the main hub.

The swirling elements may be connected to the end hub also in the recycle return section. In one aspect the swirling elements are connected to the hub part all along their spiral path.

In one aspect of the device according to the invention the one or more swirling elements continuously extend axially from the recycle return section into an extended swirl section downstream the return opening.

In a further aspect of the device the one or more swirling elements have a downstream end edge which extends at least partly axially downstream the end hub. In yet another aspect the axial length of the extended swirl section is from 10 to 300% of the outer diameter of the main hub.

The extended swirl section provides deflection of the recycle stream into the same path as the main feed flow thereby limiting formation of turbulence. The axial length of the extended swirl section can be increased to provide full deflection of the recycle stream.

In a further aspect of the device the swirling element comprises a front side and a back side according to the direction of the swirl and wherein the at least one recycle return opening is arranged adjacent to the back side of the swirling element.

In another aspect of the device the downstream end of the end hub has a concave shape.

In one aspect of the device the downstream end points of the swirl body span a convex plane.

In another aspect the end hub is tapered or convex towards the downstream end.

In a further aspect the end hub is tapered or convex towards the upstream end.

In yet another aspect the downstream end edge of the swirl element comprises a channel along at least a part of the downstream edge. In a further aspect the channel is an open channel arranged on the back side of the swirling element. In another aspect the channel is a guiding channel arranged on the front side of the swirling element.

The different elements of the demister according to the present invention are described with reference to the intended direction of the main feed flow trough the demister. The inner tube comprises an upstream gas inlet and a downstream gas outlet defining the direction of the main flow through the demister. The central axis of the inner tube is used as a further reference point to describe the positions of the different elements. Accordingly the terms axial, axially, radial and radially are to be interpreted with respect to said central axis.

This is achieved by the recycle return opening(s) in the swirl body for the recycle flow being situated in an downstream end hub of the swirl body at a position upstream a downstream end of a hub part of the swirl body. The downstream end hub of the swirl body may have a smaller diameter than the main hub of the swirl body. The downstream end hub can have a concave shape to reduce the overall drag, hence reducing the pressure drop/improving efficiency. Swirl elements extends radially and axially continuously in both hubs, main hub and end hub. The continuous swirling elements result in a positive aerodynamic effect. The swirl body is constructed to provide for the swirling elements to extend further radially inwards than the outer diameter of the main hub of the swirl body. The main hub is the upstream section of the central part of swirl body. The recycle openings are arranged in the section where the swirling element extends radially inward beyond the outer diameter of the main hub thereby the recycle flow is deflected by the swirling elements at a radial position where the pressure difference is lower and this provides for a smoother deflection and reduced impingement and formation of turbulence.

Also, the end part of the downstream end hub of the hub part of the swirl body and the downstream end edges of the swirling elements span a convex plane where the swirling elements extend further in the downstream direction close to the inner tube than at the connection to the central part of the swirl body. This leads the liquid radially outwards and provides for an increased over which liquid droplets/film can travel along the surface of the swirling element to reach the inner wall of the tube.

The improved performance by a recycle with better dP (delta pressure), less negative influence on feed flow, and further reduced liquid film/droplets entering the core of the cyclone. This is achieved by a swirling element for the feed and recycle flow being combined and continuously, where the swirling element extends further axially downstream than the main hub/central part of the swirl body.

The swirling elements extend beyond the end of the downstream end hub. The downstream end of the swirling element also referred to as the trailing edge of the swirling element is angled and or curved.

The outflow opening(s) for the recycle flow is arranged in the wall of the inner tube and/or in the end of tube.

The swirl body comprises integrated and continuously swirling elements for the main feed flow and for the recycle flow. These swirling elements also function as an extra smooth diverter, preventing liquid entrainment. The shape of the downstream end hub of the central hub of the swirl body is preferably concave which reduces overall drag coefficient, and still liquid entrainment prevention is improved as the end point at which fluid enters into the demister is at an axial distance compared to the circumferential diameter securing that droplets present in the feed stream are being caught into the vortex.

In one preferred embodiment of the invention the liquid loading of the gas to be treated is below 2 v/v %, in another embodiment of the invention the liquid loading of the gas to be treated is below 1 v/v %, in yet another embodiment of the invention the liquid loading of the gas to be treated is below 0.5 v/v %, in yet another embodiment of the invention the liquid loading of the gas to be treated is below 0.2 v/v %.

The liquid loading from the gas being recycled is believed to be higher that the liquid loading from the feed flow as the recycled gas is taken off from a liquid film. The integrated and continuously swirling elements from the main feed flow and for the recycle flow means that the recycle not only ensures a better separation of the recycle, the recycle flow itself contributes to improved separation of the feed flow, especially is this important when feed flow has particular low liquid loading. The recycle flow improves the formation and maintenance of liquid film along the inner tube of the demister as it has higher liquid loading than the feed fluid. The liquid film is established earlier to which droplets are added, and the liquid film will be more stable as less will be added later, considering the recycle flow already is diverted. A stable liquid film will contribute to reduced re-entrainment from the liquid film. The fact that more liquid is separated earlier also provides better space for remaining liquid in the gas to be added to the liquid film downstream the swirl element.

The construction of the swirl body according to the present invention provides for a reduced overall pressure loss and thereby provides for the possibility of increasing the velocity of the main feed through the demister. The increase in velocity will have a positive effect on the efficiency in that the cut size is reduced.

The location and orientation of recycle gas stream return openings are such that the recycle gas stream motivates the transportation of liquid away from central low-pressure region. This is to minimize and preferably avoid liquid creep. Liquid creep is the main cause of liquid flow towards the centre. The prevention of liquid re-entrainment of liquid present at or on the swirl body is an important effect of the present invention, as this according to the prior art solutions can not be obtained without the use of a liquid creep ring or divergence means.

The end edges of the swirling elements are angled spanning a convex plane so that the trailing edge of the swirling elements facilitate transport of liquid on the blade surface towards the inner wall of the inner cyclone tube.

In one embodiment the swirl angle of the swirling element is 25-45 degrees.

The ratio between the diameter of the main hub of the swirl body and the inner diameter of the inner tube is preferably 0.25-0.75.

The length of the swirling elements is preferably 1-2 the inner diameter of the inner tube.

The open area of the inner tube outflow opening is preferably equal to cross sectional area of the inner tube.

### BRIEF DESCRIPTION OF THE DRAWINGS

The present invention will be described in further detail with reference to the enclosed figures where

FIG. 1a illustrates a cross sectional view a long the longitudinal axis of an axial flow demister.

FIG. 1b illustrates a cross sectional view along the line E-E on FIG. 1a, perpendicular to the longitudinal axis.

FIG. 1c shows a close up of the downstream end section of the swirl body of FIG. 1a.

FIG. 2 schematically illustrates a second embodiment of a swirl body;

FIG. 3 schematically illustrates a third embodiment of a swirl body;

FIG. 4 schematically illustrates a fourth embodiment of a swirl body;

FIG. 5 schematically illustrates a fifth embodiment of a swirl body;

FIG. 6 schematically illustrates a sixth embodiment of a swirl body;

FIG. 7 schematically illustrates a seventh embodiment of a swirl body;

FIG. 8 schematically illustrates an eight embodiment of a swirl body;

FIG. 9 schematically illustrates a ninth embodiment of a swirl body;

FIG. 10 schematically illustrates a tenth embodiment of a swirl body;

FIG. 11a schematically illustrates an eleventh embodiment of a swirl body;

FIG. 11b illustrates a cross sectional view of the eleventh embodiment of a swirl body;

FIG. 12a schematically illustrates a twelfth embodiment of a swirl body;

FIG. 12b illustrates a section of a cross sectional view a long the longitudinal axis of the twelfth embodiment of a swirl body;

FIG. 13a schematically illustrates a thirteenth embodiment of a swirl body;

FIG. 13b illustrates a section of a cross sectional view a long the longitudinal axis of the thirteenth embodiment of a swirl body;

FIG. 14a illustrates a perspective view of a fourteenth embodiment of a swirl body;

FIG. 14b illustrates a side view of the fourteenth embodiment of a swirl body;

FIG. 15 schematically illustrates a fifteenth embodiment of a swirl body;

FIG. 16a schematically illustrates a side view of a sixteenth embodiment of a swirl body, with only one swirl element included;

FIG. 16b schematically illustrates the sixteenth embodiment of a swirl body, with all swirl elements included;

FIG. 17 schematically illustrates the downstream end hub of a seventeenth embodiment of a swirl body, with only one swirl element included;

FIG. 18a schematically illustrates a side view of an eighteenth embodiment of a swirl body, with only one swirl element included;

FIG. 18b schematically illustrates the eighteenth embodiment of a swirl body;

FIG. 19 schematically illustrates a nineteenth embodiment of a swirl body;

FIG. 20 schematically illustrates a twentieth embodiment of a swirl body, with only one swirl element included;

FIG. 21 schematically illustrates a twenty-first embodiment of a swirl body, with only one swirl element included;

FIG. 22 schematically illustrates a side view of a twenty-second embodiment of a swirl body, with only one swirl element included;

FIG. 23 schematically illustrates an embodiment of the downstream end of a swirl element;

FIG. 24a schematically illustrates a cross sectional view in the direction of the inner tube of a demister with a twenty-third embodiment of a swirl body;

FIG. 24b schematically illustrates the twenty-third embodiment of a swirl body;

FIG. 25 schematically illustrates a cross sectional view in the direction of the inner tube of a demister with a twenty-fourth embodiment of a swirl body;

FIG. 26 schematically illustrates a cross sectional view in the direction of the inner tube of a demister with a twenty-fifth embodiment of a swirl body;

FIG. 27 schematically illustrates a cross sectional view in the direction of the inner tube of a demister with a twenty-sixth embodiment of a swirl body;

FIG. 28 schematically illustrates a cross sectional view in the direction of the inner tube of a demister with a twenty-seventh embodiment of a swirl body.

FIG. 29A schematically illustrates a perspective view of a twenty-eight embodiment of a swirl body;

FIG. 29B schematically illustrates a perspective view from a different angle of a twenty-eight embodiment of a swirl body

FIG. 29C schematically illustrates a cross sectional view of the hub part of the twenty-eight embodiment of a swirl body; and

FIG. 30 schematically illustrates a cross sectional view in the direction of the inner tube of a demister with a twenty-eight embodiment of the swirl body shown in perspective.

### PRINCIPAL DESCRIPTION OF THE INVENTION

The present invention will now be discussed in further detail with reference to the enclosed figures. The figures are schematic illustrations of embodiments of systems and methods according to the present invention. A person skilled in the art will understand that some details are enhanced or limited to illustrate the effect of the present invention. In the figures equal reference signs are used to refer to equal elements.

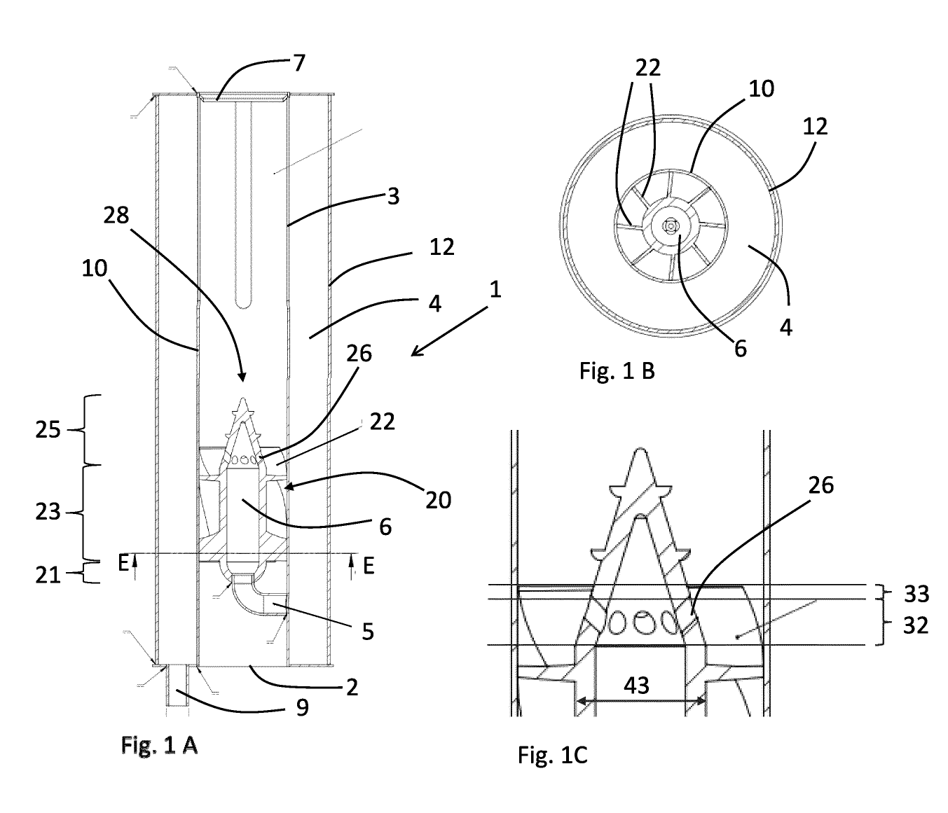

FIG. 1A shows a one embodiment of an axial flow demister 1 according to the present invention. The gas stream to by dried/demisted would enter through the inlet 2 at the up stream end of an inner tube 10, passes the swirl body 20 where the stream will be put into a swirling motion by swirl element(s) 22. The swirling elements have an at least partly spiral configuration around a central hub part of the swirl body 28. The swirl elements are connected to the hub part along an at least partly spiral path. The swirling will make the liquid, which has a higher density than the gas concentrate as a liquid film on the inner surface of the inner tube 10. The liquid film will travel with the gas stream in the direction of the dry gas outlet 7 at the downstream end of the tube 10 until it reaches the inner tube outflow opening 3 in the form of slot(s) in the inner tube providing an opening for the liquid film and a part of the gas stream. The openings 3 can have any configuration allowing the liquid film and the recycle stream to pass there through. The slots provide access to an annular channel 4 arranged between the inner tube 10 and a concentric outer tube 12. In the annular channel the main direction of flow is opposite the flow direction in the inner tube 10. The liquid will flow down and can be removed continuously or n intervals via liquid outlet 9. The gas stream is recycled via recycle channel 5, an internal channel 6 in the swirl body 20 and the recycle return opening(s) 26 in the swirl body 20.

FIG. 1B illustrates the cross section of the demister along the line E-E on FIG. 1A. The inner tube 10 and the outer tube 12 form the annular channel 4. The swirl elements 22 in the inner tube 10 provide swirling motion to a gas stream passing there trough. Also visible is the internal channel 6 in the swirl body 20.

The above general description of the demister and general working principal is equally valid for the other embodiments of the present invention disclosed on the other figures.

The hub part 28 of the swirl body comprises in the axial direction of the intended main flow an upstream end section 21, a main cylindrical hub 23, and a tapered downstream end hub 25.

FIG. 1C is a close up view of the downstream end section of the swirl body of FIG. 1A. The swirl body of a demister according to the present invention comprises a recycle return section 32 and an extended swirl section 33. The recycle return section comprises the recycle opening(s) 26. Further the recycle return section 32 comprises a swirling element 22 that extends radially further inwards than the outer diameter 43 of the main hub 23. The extended swirl section 33 is a section downstream the recycle return section comprising swirling elements. The continuous swirling element(s) 22 accordingly extend axially in the downstream direction (the intended direction of the main flow) from the main hub past the recycle return section and through the extended swirl section.

In the embodiment illustrated on FIG. 1A the swirl elements 22 are fixed to the main cylindrical hub 23 and extend in the axial direction into the tapered downstream end hub 25. The swirl elements 22 are connected to part of the tapered surface. The recycle return openings 26 are arranged in the tapered hub 25. It is believed that this arrangement of the recycle return openings provides the advantage that the reduction of the radius of the swirl body due to the taper provides an increase of the radius of the annulus between the internal wall of the inner tube and the swirl body. This increased annulus radius reduces the pressure in the gas flow and the recycled gas is return to a gas flow at reduced pressure compared to a situation wherein the return openings were arranged on the main cylindrical hub 23. The recycle gas flow is driven by the pressure difference, so the flowrate of recycle gas will be reduced by the reduced pressure and the reduced flowrate will result in reduced disturbing of the main flow by the recycle flow. Further by arranging the return openings on the tapered surface the recycle return openings are brought closer to the centre of the tube and thereby the centre of the main flow, this is also believe to limit the disturbing of the main flow.

The swirl elements 22 extend in the downstream direction past the recycle openings 26. This arrangement provides for the recycle stream being brought in contact with the swirl elements when leaving through the openings 26. This recycle flow is believed to assist any liquid droplets/film on the downstream end hub 25 of the hub part 28 or on the surface of the downstream parts of the swirl elements to leave said surface and re-enter the swirling gas stream where it will be forced out to the wall of the inner tube by the cyclonic effect.

The swirling elements 22 run continuously from the main hub 23 into the downstream end hub 25 thereby providing for smooth swirling motion of the main fluid stream as well as the recycle stream also influenced by the swirling elements 22.

FIG. 1A also includes two flanges on the tapered downstream end hub 25 of the hub part of the swirl body. These flanges are optional features and are included to force any liquid droplets or film on the surface of the hub part 28 of the swirl body downstream the swirl elements to leave the hub part at the edge of the flanges in a direction towards the inner wall.

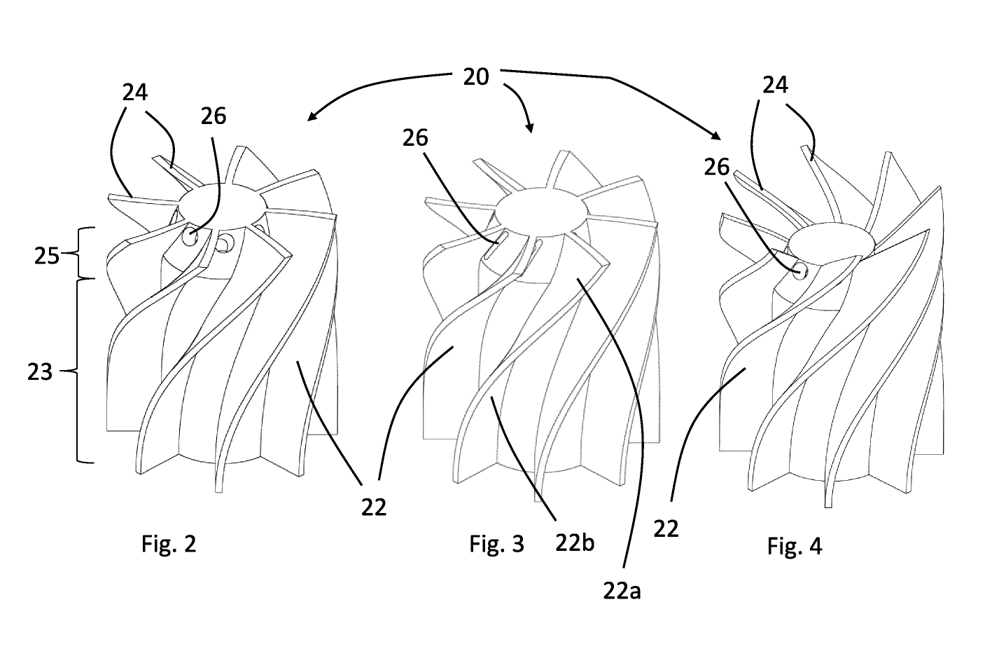

FIG. 2 illustrates a second embodiment of the swirl body 20 for an axial demister. In this embodiment the recycle return openings 26 are circular openings arranged in the tapered downstream end hub 25 of the central part of the swirl body 20. The swirl elements 22 protrude from the central part of the swirl body and are fixed to the central part of the swirl body both in the cylindrical main hub 23 and the downstream end hub 25. The downstream end edges 24 of the swirl elements 22 protrude in the in the intended direction of flow with a similar length as the central part of the swirl body. The extended swirl elements are believed to provide the recycle gas with a swirling motion so that liquid droplets present in the recycle stream experience a cyclone effect and are transported to the inner wall of the inner tube and are less likely to follow the main gas stream in the centre of the tube towards the dry gas outlet.

FIG. 3 illustrates a swirl body 20 with elongated recycle return openings 26 arranged in the tapered downstream end hub of the hub part close to the back side 22b of the swirling element.

The front side 22a and backside 22b are defined according to the direction of rotation of the spiral configuration of the swirl elements. In the swirl bodies illustrated on FIGS. 2 and 3 the swirl elements spiral to the right in the intended direction of flow, according to the right hand rule and the front side 22a is to the left of the back side 22b.

The arrangement of the openings close to the back side is expected to have the effect that liquid droplets in the recycle stream will collide with the back side and move along the back side as droplets or as a liquid film towards the inner wall of the inner tube thereby reducing the risk of the droplets being reintroduced to the gas stream.

Further the elongated openings 26 distribute the recycle flow over a longer axial distance increasing the length over which the recycle flow is subject to the cyclone effect.

FIG. 4 illustrates an embodiment of the swirl body wherein the end edges 24 of the swirling elements extend downstream the downstream end hub of the central part. The swirling elements extend beyond the end of the end of the central part and the swirling elements are accordingly extended in the axial direction. The arrangement is intended to further reduce the risk of droplets on the backside of the swirling elements to be reintroduced into the gas stream, as the droplets can follow the backside in the direction of the swirl for a longer time thereby provide increased probability that the droplets reach the inner wall of the tube before they reach the end edge 24 of the swirling element.

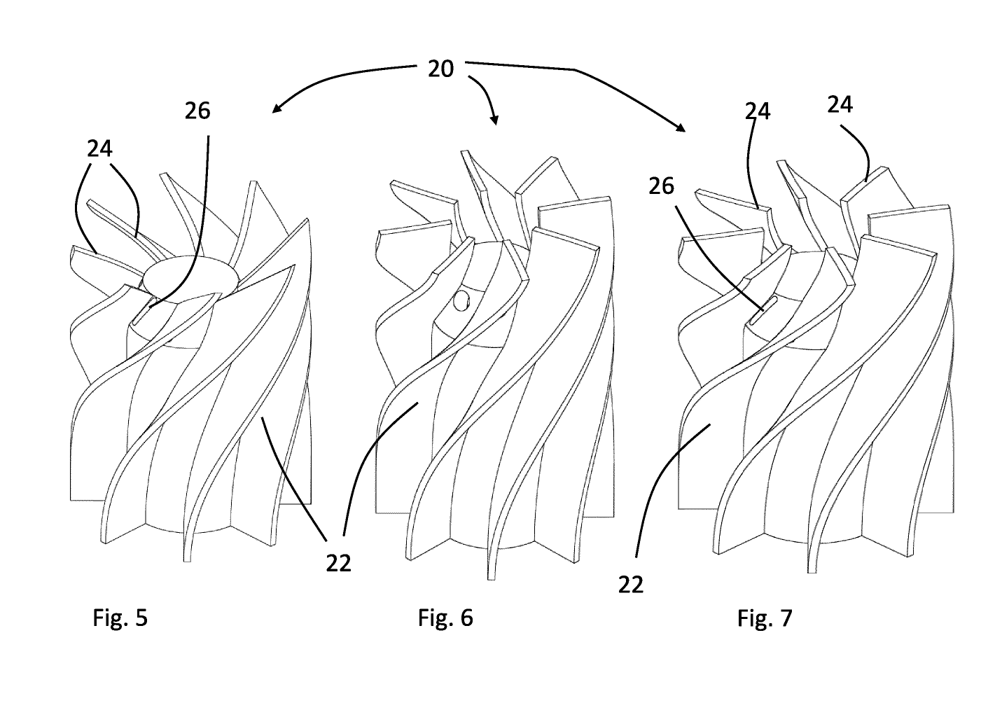

FIGS. 5 to 7 alternative embodiments wherein the downstream end edge 24 of the swirling elements extend downstream the downstream end hub of the hub part 28. In FIGS. 4 and 5 the downstream end edges 24 are inwardly tapered towards the central axis providing the swirl body with an overall convex downstream end.

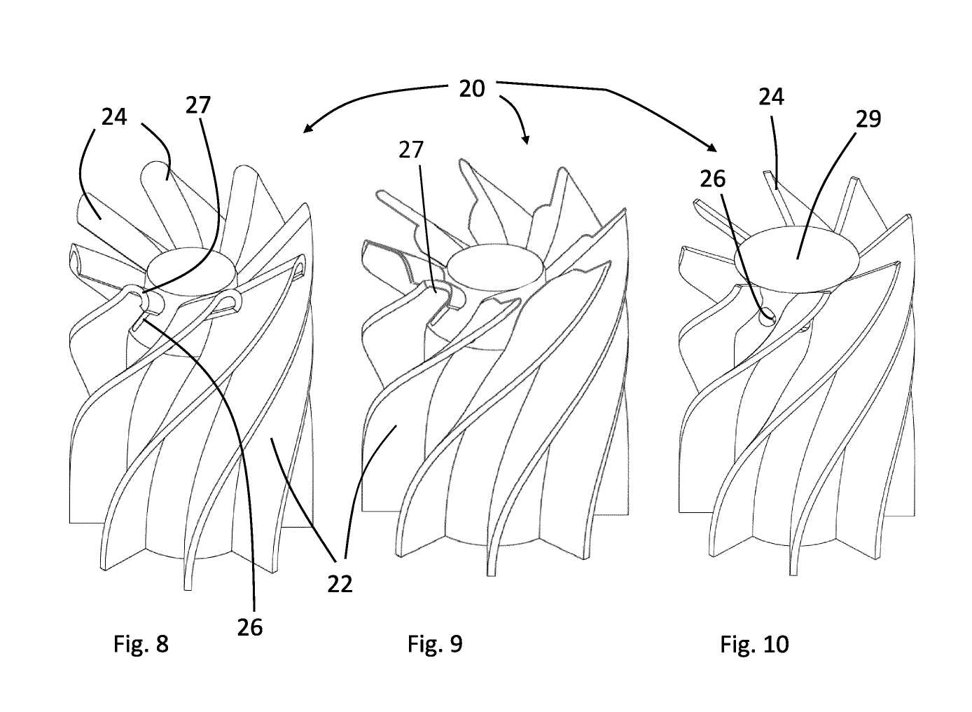

FIGS. 8 and 9 discloses embodiments of the present invention wherein the downstream end of the swirling elements comprises an open channel 27 along at least part of the downstream end edge 24. The channel is open towards the backside of the swirling elements. The open channels are arranged to guide droplets present on the swirling elements towards the inner wall of the inner tube and were the re-entering/entrainment of droplets in the gas phase is further limited. In FIG. 8 the open channel runs all along the downstream end edge whereas in FIG. 9 the open channel is only arranged along the section of the downstream end edge closest to the hub part of the swirl body.

FIG. 10 illustrates an alternative embodiment wherein the central part at the downstream hub end comprises an end plate 29 with a diameter larger than the diameter in the tapered downstream end hub 25. The end plate 29 is believed to provide the additional function of liquid creep prevention in that any liquid creeping on the surface of the central part of the swirl body will be forced by the main fluid flow towards the upstream side of the end plate 29. The liquid will then follow the upstream side until it reaches the edge of the end plate 29. Here the liquid is related into the main flow at a position where the main flow is in a swirling motion and the liquid will by the swirling motion be forced towards the inner wall of the inner tube.

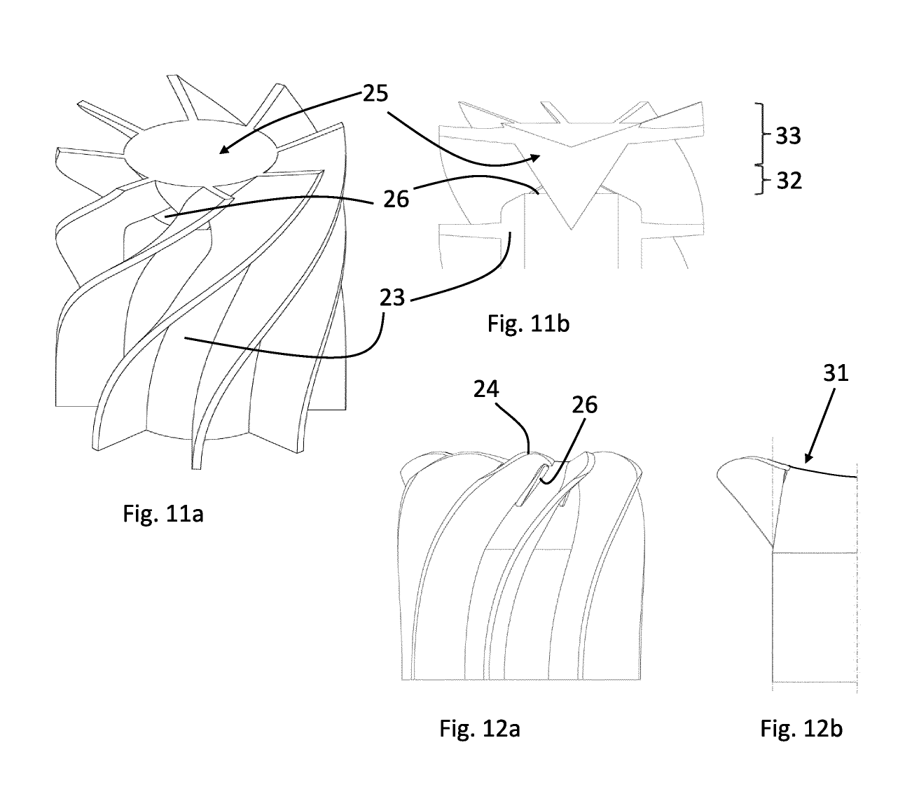

FIGS. 11a and 11b illustrate an embodiment of the swirl body 20 where the end hub 25 of the central part is configurator as a cone with the tip in the direction of the gas inlet and the main hub 23 of the central part is configured as a cylindrical tube. The tip of the cone is arranged with in the cylindrical tube thereby forming an annular recycle return opening 26.

FIGS. 12a and 12b illustrate a further embodiment of the swirl body wherein the downstream end edge 24 of the swirling element is configured to surround the downstream end of the recycle return opening 26. The swirling element 22 thereby surrounds approximately 50% of the circumference of the recycle return opening 26. Further as can be seen especially in FIG. 12b the downstream end surface of the central part together with the downstream ends of the swirling elements form a convex downstream end surface 31.

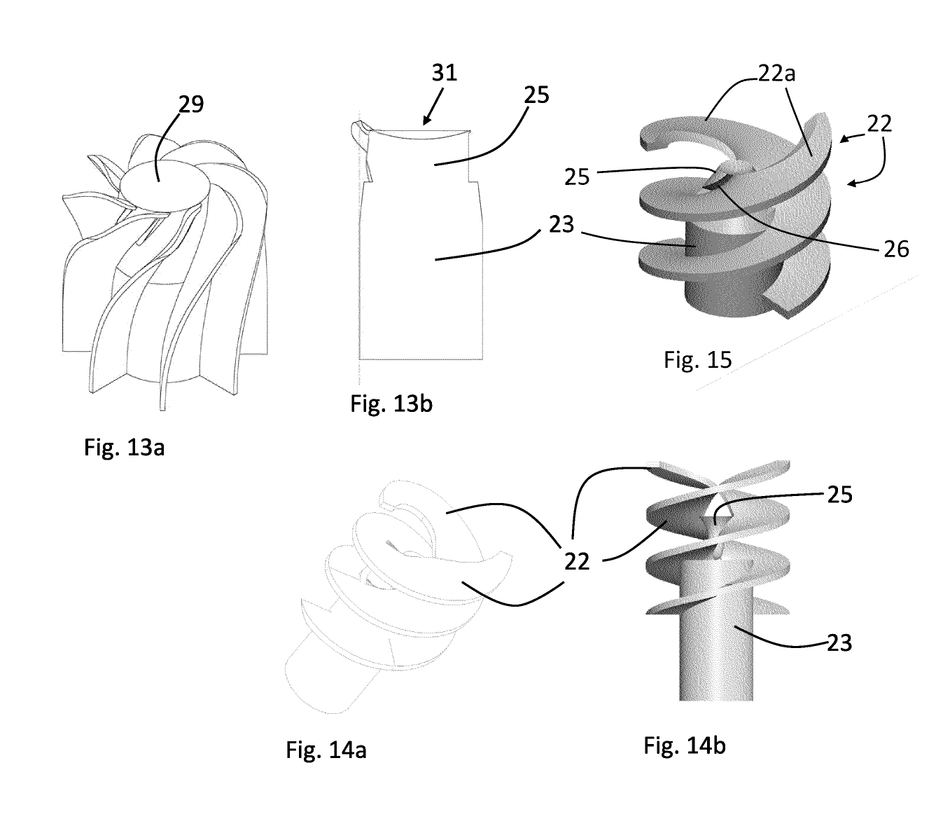

FIGS. 13a and 13b illustrate an alternative embodiment including an end plate 29 as described in connection with FIG. 10. The end plate 29 in this embodiment is provided with a convex surface which together with the downstream ends of the swirling elements provides a convex downstream end surface 31. The diameter of the downstream end hub 25 is smaller than the diameter of the main hub 23. The downstream end hub 25 is not equally tapered in the axial direction but comprises sections of cylindrical shape.

FIGS. 14a and 14b illustrate an embodiment of the swirl body comprising two helical swirling elements 22 twisted together around the main hub 23 and the downstream end hub 25 of the central part. The end hub 25 of the central part is configurator as a cone with the tip in the direction of the gas inlet and the main hub 23 of the central part is configured as a cylindrical tube. In this embodiment the tip of the cone is not inserted in the downstream opening of the cylindrical tube.

FIG. 15 illustrate a swirl body comprising two helical swirling elements 22 twisted together around the main hub 23 and the downstream end hub 25 of the hub part. The recycle return opening 26 is arranged in a tapered downstream end hub 25 adjacent to the front surface of the swirling element

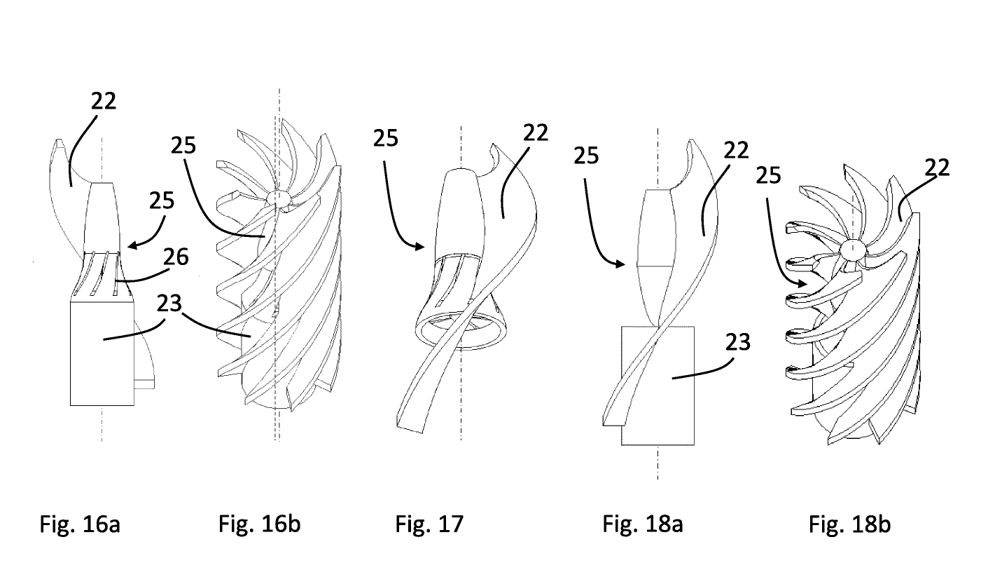

FIGS. 16a and 16b illustrate a further embodiment of the swirl body, to show the details only on swirl element is included in FIG. 16a. The openings 26 are configured as slits in a tapered section of the downstream end hub 25, the openings serve two purposes in this embodiment. Firstly, they are adapted to receive a connection part of the swirling element to secure this to the central part and secondly they provide openings for the recycle return.

FIG. 17 illustrates an end hub 25 of a swirl body where only one swirling element 22 is included to better illustrate the details. The openings 26 are configured as slits in a tapered section of the downstream end hub 25, the openings serve two purposes in this embodiment. Firstly, they are adapted to receive a connection part of the swirling element to secure this to the central part and secondly they provide openings for the recycle return.

FIGS. 18a and 18b illustrates an alternative embodiment where the downstream end hub 25 is tapered in both directions upstream and downstream. The main hub 23 has the shape of a tube with a downstream opening forming the opening 26 for the recycle stream. The upstream end of the downstream end hub is concave and arranged in the middle of the opening 26. The recycle stream coming out of the opening 26 is forced smoothly radially outwards by the downstream end hub 25 and into a swirling motion by the swirling elements 22 that run continuously from the outside of the main hub 23 to the outside of the downstream end hub 25.

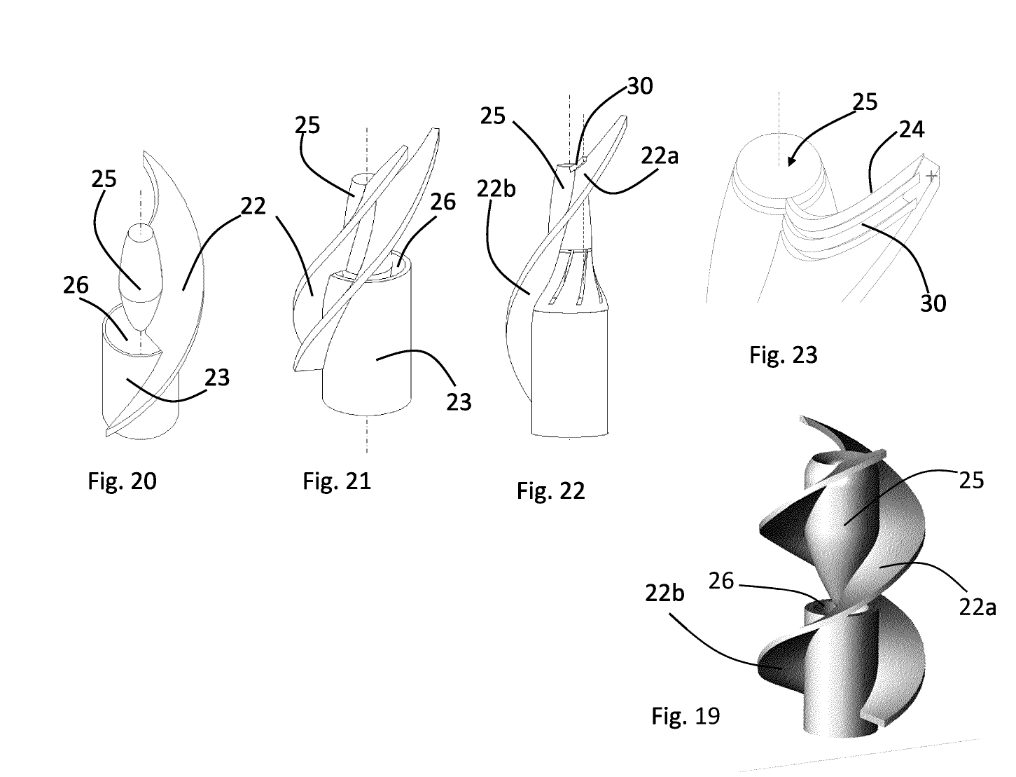

FIG. 19 illustrate another embodiment of the swirl body with a similar tube shape main hub as in FIGS. 18a and 18b. The downstream end hub is constructed with a bottle like shape where the neck of the bottle points in the upstream direction towards the opening 26. Illustrated are two swirling elements but additional swirling elements 22 may be included. The downstream end surface of the downstream end hub 25 has a convex shape.

FIGS. 20 and 21 illustrate further alternative embodiments of the swirl body where the main hub 23 is tube shaped. In FIG. 20 the upstream end of the down stream end hub is arranged at the opening 26 of the tube shaped main hub whereas in FIG. 21 a part of the downstream end hub protrudes into the tube shaped hub 23. The configuration on FIG. 21 is believed to provide an increased speed of the recycle stream leaving the opening 26 thereby providing for a smooth mixture with the main stream. The protruding section may also have the effect of forming a swirling flow within the tube close to the opening 26.

FIGS. 22 and 23 illustrate further embodiments of a swirling body according to the present invention wherein the swirling element 22 further comprise a guiding channel 30 at the downstream end edge 24 of the swirling element on the front side 22a of the swirling element. The guiding channel may be arranged on a section of the end edge 24 closest to the centre as in FIG. 22 or be arranged to follow the end of the swirling element from the hub 25 and to the inner wall of the inner tube (not included in the figures). The guiding channel 30 is arranged to guide any liquid film or droplets present on the front side 22a of the swirling elements or on the surface of the central part to the inner wall of the inner tube with limited entrainment thereof.

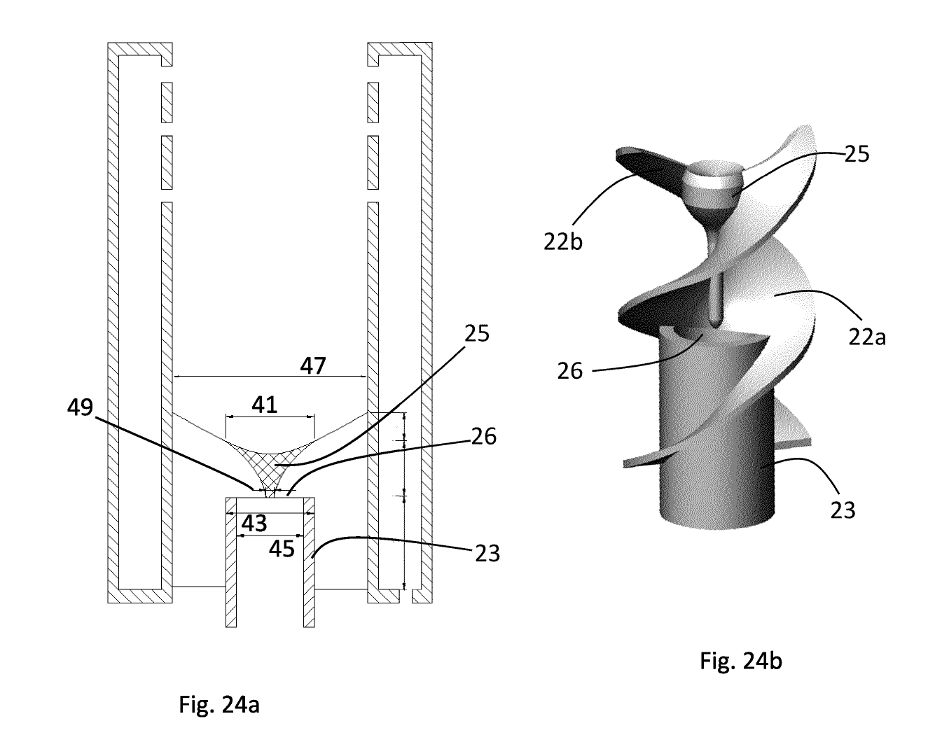

On the FIGS. 24a and 24b an embodiment of the swirl body is disclosed, the drawings are not drawn to scale. Here the main hub 23 is tube shaped with an outer diameter 43 and an inner diameter 45. The downstream end hub 25 comprises a downstream part with a diameter 41 and an upstream section with a diameter 49. The diameter of the inner tube is referred to as 47. The diameter 41 is larger than the diameter 49. In one preferred embodiment the diameter 41 and 43 are similar. This configuration will have the effect that the pressure difference between the recycle stream and the main flow is limited and this results in limited disturbance of the main flow when the streams are brought together. In yet another embodiment the size of diameter 41 is in the range of 90-100% of the size of the diameter 43.

In yet another embodiment the size of diameter 41 is in the range of 70-100% of the size of the diameter 43.

In yet another embodiment the size of diameter 41 is in the range of 80-100% of the size of the diameter 43.

In yet another embodiment the size of diameter 41 is in the range of 90-100% of the size of the diameter 43.

In yet another embodiment the size of diameter 41 is in the range of 90-110% of the size of the diameter 43.

In yet another embodiment the size of diameter 41 is in the range of 70-110% of the size of the diameter 43.

As the FIGS. 24a and 24b are not drawn to scale, they illustrate the above embodiments without providing a specific figure for each of the different diameter ranges.

In one embodiment the size of diameter 41 is larger than the size of diameter 45.

Diameter as used here refers to the cross sectional diameter perpendicular to the longitudinal axis of the inner tube.

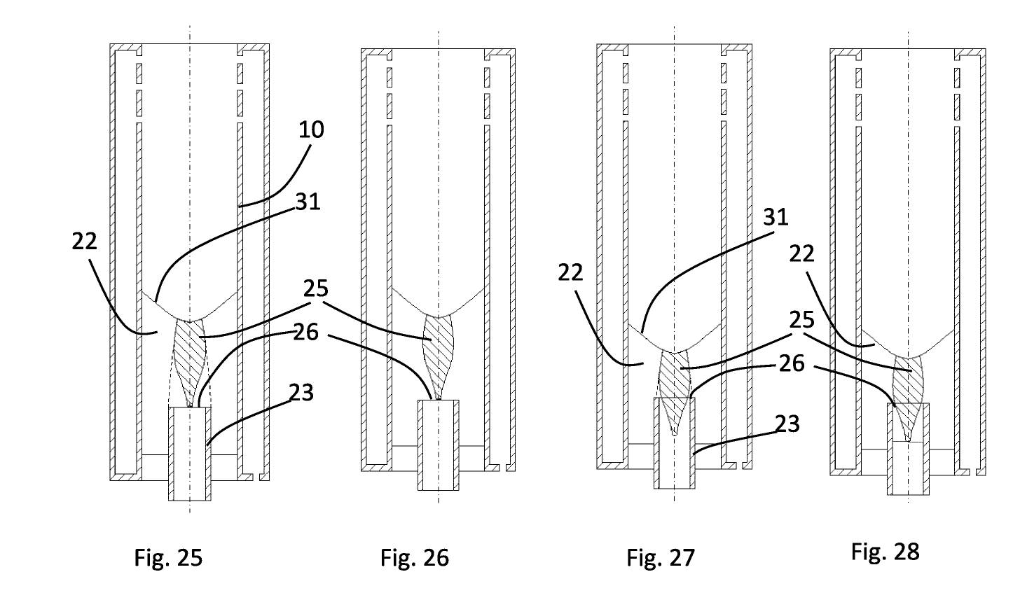

The FIGS. 25 and 26 illustrate an embodiment of the demister wherein the main cylindrical hub 23 of the central part of the swirl body is in the form of a tube with a downstream opening 26. The downstream end hub 25 of the central part of the swirl body is bottle shaped with the bottle neck arranged at the opening 26. The downstream end of the downstream end hub is convex and together with the downstream ends of the swirling elements 22 it spans a convex plane 31. In FIG. 25 the downstream end hub is secured to the main hub by part of the swirling elements 22 that are connected to a part of the surface of the downstream end hub 25 and to a part of the outer surface of the main hub 23. In FIG. 26 the swirling elements are connected to downstream end hub 25 along the entire axial length thereof and are also connected to or rest against the downstream end surface of the tube 23. In FIG. 25 the small diameter of the neck part is believed to provide for a swirling motion in the recycle gas whereas the increasing diameter of the downstream end of the end hub 25 secures that liquid in the return gas or droplets released from the surface of the downstream end hub 25 are released at a distance from the axis and thereby the centre of the vortex to secure that the droplets are caught by the cyclonic swirl and transported to the inner wall of the inner tube.

The FIGS. 27 and 28 disclose embodiments similar to FIGS. 25 and 26 but wherein the neck of the bottle shaped downstream end hub 25 is introduced into the opening 26 of the tube shaped main hub 23. This is believed to have the effect that the velocity of the recycle stream is increased due to the narrowing of the opening 26. The increased velocity will provide for a smooth introduction of the recycle stream into the main stream limiting the formation of turbulence. In FIG. 28 the swirling elements 22 extend into internal recycle channel of the main hub 23, thereby the recycle stream will swirl similar to the main feed stream and an even smoother mixing with minimised formation of turbulence is expected to be achieved.

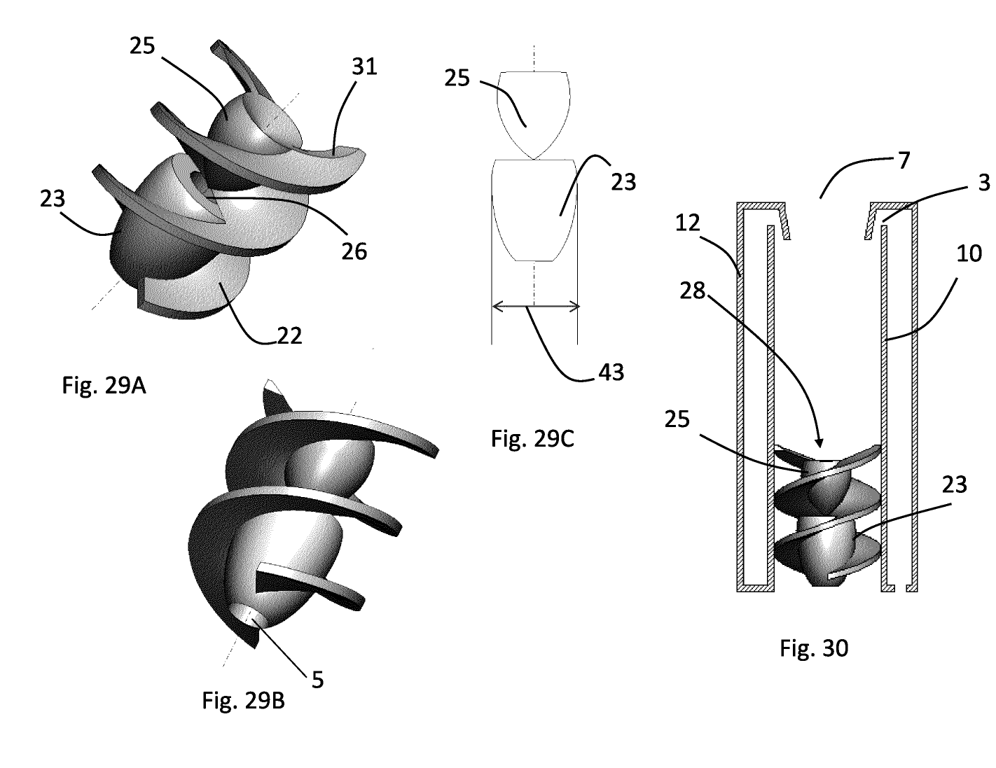

FIGS. 29A, 29B and 29C illustrate an embodiment of the swirl body. In this embodiment, the main hub 23 is barrel shaped. FIG. 29C illustrates the cross section of the hub part and illustrates how the outer diameter 43 of the main hub 23 is measured. Visible on FIG. 29A is the convex surface of the downstream end of the end hub 25 that together with the end edges of the swirling elements span a convex plane 31.

FIG. 30 illustrates a cross sectional view of the inner tube 10 and the outer tube 12. The inner tube outflow opening 3 is arranged at the end of the inner tube 10 and separated from the dry gas outlet 7 by an internal flange on the outer tube 12.

### REFERENCE NUMBERS

1 axial demister
2 gas inlet
3 inner tube outflow opening
4 annular channel
5 recycle channel
6 internal recycle channel in swirl body
7 dry gas outlet
9 liquid outlet
10 inner tube
12 outer tube
20 swirl body
21 upstream section of swirl body
22 swirling element
22a front side of swirling element
22b back side of swirling element
23 main hub of swirl body
24 downstream end edge of swirling element
25 downstream end hub of swirl body
26 recycle return opening
27 open channel
28 hub part of swirl body
29 end plate
30 guiding channel
31 downstream end surface
32 recycle return section
33 extended swirl section
41 diameter of downstream end hub of the hub part of the swirl body
43 diameter of main hub of the swirl body
45 inner diameter of recycle channel
47 inner diameter of inner tube
49 diameter of upstream part of downstream end hub.

1. Device for removal of a liquid from a gas-liquid mixture, comprising an inner tube with an upstream gas-liquid mixture inlet and a downstream gas outlet, a swirl body arranged within said inner tube, at least one opening in the wall or at the end of the inner tube downstream the swirl body for a recycle flow, a conduit from the at least one opening in the wall of the inner tube to at least one recycle return opening in the swirl body, wherein the swirl body comprises a hub part and one or more swirling elements connected thereto, wherein the hub part comprises a cylindrical or barrel shaped main hub with an outer diameter and a downstream end hub, wherein the at least one recycle return opening is arranged in the end hub, wherein the one or more swirling elements are continuous and directly connected to the main hub and the end hub, characterized in that the swirl body comprises a recycle return section comprising said at least one return opening in the end hub and that within the recycle return section the one or more swirling element(s) extend further radially inwards than the outer diameter of the main hub.

2. Device according to claim 1, wherein the one or more swirling elements continuously extend axially from the recycle return section into an extended swirl section downstream the return opening.

3. Device according to claim 1, wherein the one or more swirling elements have a downstream end edge which extends at least partly axially downstream the end hub.

4. Device according to claim 2, wherein the axial length of the extended swirl section is from 10 to 300% of the outer diameter of the main hub.

5. Device according to claim 1, wherein the swirling element comprises a front side and a back side according to the direction of the swirl and wherein the at least one recycle return opening is arranged adjacent to the back side of the swirling element.

6. Device according to claim 1, wherein the downstream end of the end hub has a concave shape.

7. Device according to claim 1, wherein the downstream end points of the swirl body span a convex plane.

8. Device according to claim 1, wherein the end hub is tapered or convex towards the downstream end.

9. Device according to claim 1, wherein the end hub is tapered or convex towards the upstream end.

10. Device according to claim 1, wherein the downstream end edge of the swirl element comprises a channel along at least a part of the downstream edge.

11. Device according to claim 10, wherein the channel is an open channel arranged on the back side of the swirling element.

12. Device according to claim 10, wherein the channel is a guiding channel arranged on the front side of the swirling element.

13. Device according to claim 1, wherein the end hub comprises a downstream part with a diameter and an upstream section with a diameter, where the diameter of the downstream part is larger than the diameter of the upstream section.

14. Device according to claim 13, wherein the diameter of the downstream part of the end hub is in the range of 70-110% of the size of the outer diameter of the main hub.
